(19) United States
(12) Patent Application Publication
(10) Pub. No.: US 2010/0095505 A1
(43) Pub. Date: Apr. 22, 2010

(54) METHOD OF REPLACING A DAMAGED BONDED STUD ON A COMPOSITE BYPASS DUCT

(76) Inventor: BRIAN BERTHELET, St-Bruno de Montarville (CA)

Correspondence Address: OGILVY RENAULT LLP (PWC), 1, PLACE VILLE MARIE, SUITE 2500, MONTREAL, QC, H3B 1R1, CA

(21) Appl. No.: 12/254,868

(22) Filed: Oct. 21, 2008

(51) Int. Cl. B23P 6/00

(52) U.S. Cl. 29/402.08

(57) ABSTRACT

A method of replacing a stud bonded to an outer surface of a bypass duct of a turbofan gas turbine engine is disclosed. The surface is made of a composite material. The stud has a base and had a stem that has been previously removed by separating the stem from the base. The method includes: reducing the base in thickness; and then bonding a replacement stud over a remaining portion of the base.

### TECHNICAL FIELD

The technical field relates generally to gas turbine engines, and more particularly to the repair of composite bypass ducts for aero turbofans.

### BACKGROUND

Some models of gas turbine engines have bypass ducts provided with parts that are made of one or more composite materials. Composite materials, however, often tend to be somewhat less tolerant to mishandling compared to other materials. For instance, composite parts can be susceptible to fraying if they are hit by a tool, such as a chisel or a drift, during a maintenance operation. An entire bypass duct can then be inadvertently ruined if one of its composite parts is damaged by such mishandling.

Bypass ducts may include studs for holding wiring or for similar fixing purposes. The studs often bear no significant loads when a gas turbine engine is operated, but they can nevertheless be damaged, particularly in the case of composite bypass ducts, such as during a maintenance operation. For instance, a stud can be inadvertently bent, have its threads damaged, or become loose or be broken off. A damaged stud may require that the entire composite bypass be replaced by a new one. Room for improvements thus exists.

### SUMMARY

In one aspect, the present concept provides a method of replacing a stud bonded to a composite bypass duct of a gas turbine engine, the stud comprising a stem attached to a base, the method comprising the steps of: removing substantially all of the stem of the stud from the base; reducing the base in thickness to a desired thickness; and then bonding a replacement stud over a remaining portion of the base.

In another aspect, the present concept provides a method of replacing a stud bonded to an outer surface of a bypass duct of a turbofan gas turbine engine, the surface being made of a composite material, the stud having a base and had a stem that has been previously removed by separating the stem from the base, the method comprising the steps of: reducing the base in thickness; and then bonding a replacement stud over a remaining portion of the base.

Further details on these and other aspects will be apparent from the detailed description and figures included below.

### DESCRIPTION OF THE FIGURES

FIG. 1 is an isometric and partially exploded view showing an example of a composite bypass duct with studs, the studs being shown before being bonded to the composite bypass duct;

FIG. 2 is a side view showing an example of a stud;

FIG. 3 is a view similar to FIG. 2, showing an example of a damaged bonded stud;

FIG. 4 is a semi-schematic view showing the damaged bonded stud of FIG. 3 being replaced;

FIG. 5 is a side view showing an example of a replacement stud being bonded over what is left of the base plate of a previously bonded stud;

FIG. 6 is a semi-schematic longitudinal cross section of the composite bypass duct showing a bonded stud provided over a curved surface portion; and

FIG. 7 is a view similar to FIG. 6, showing a bonded stud provided over a flat surface portion.

### DETAILED DESCRIPTION

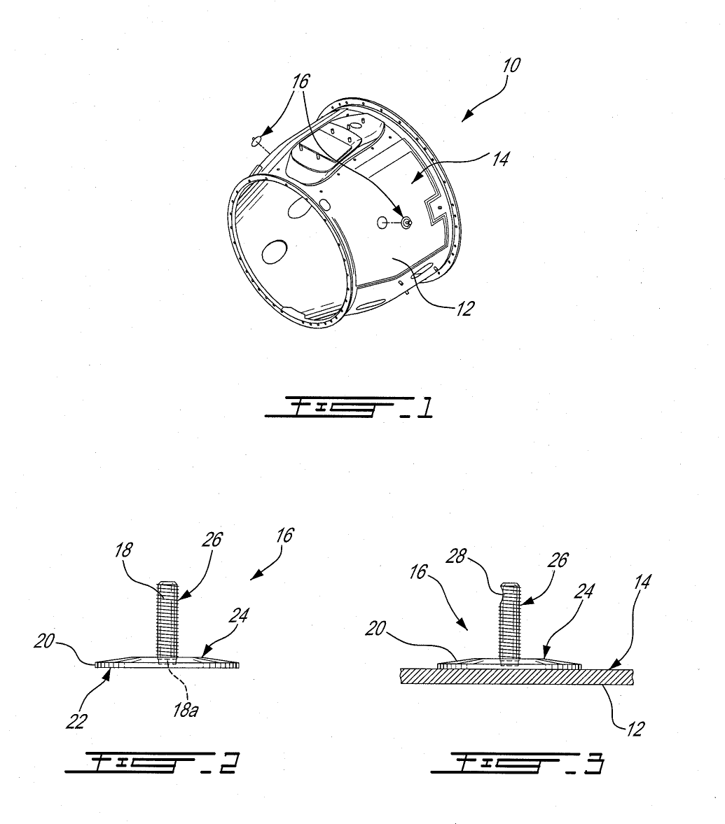

FIG. 1 is an isometric and partially exploded view showing an example of a bypass duct 10 of a gas turbine engine. The bypass duct 10, hereafter referred to as the “composite bypass duct”, comprises at least some parts that are made of one or more composite materials. In the illustrated example, the composite bypass duct 10 comprises a wall 12 made of such material. The wall 12 defines an outer surface 14 to which two studs 16 are attached once the composite bypass duct 10 is fully assembled. It should by noted that the composite bypass duct 10 can have parts that are not made of a composite material.

FIG. 2 is a side view showing an example of a stud 16. Other stud models are also possible. The illustrated stud 16 comprises a stem 18, in this case a stem entirely threaded along its length. The stem 18 has a bottom end 18a that is embedded into a base, which base can be for instance a base plate 20, as in the illustrated example. The bottom end 18a of the stem 18 can be for instance molded in the base plate 20. Other attachment methods are also possible. The base plate 20 of the illustrated example has a circular shape, a flat bottom surface 22 and a chamfered upper rim 24. Other shapes and surface designs are possible as well. Studs 16 can be provided with a stem made of a relatively rigid material and a base plate made of a different material. For instance, the stem 18 can be made of metal, such as stainless steel, and the base plate 20 can be made of a polymer or a composite material, such as fiberglass. Other materials are also possible. It is also possible to use the same material for both the stem 18 and the base plate 20. A person skilled in the art will know how to design studs and therefore, the design of studs need not be discussed in further details.

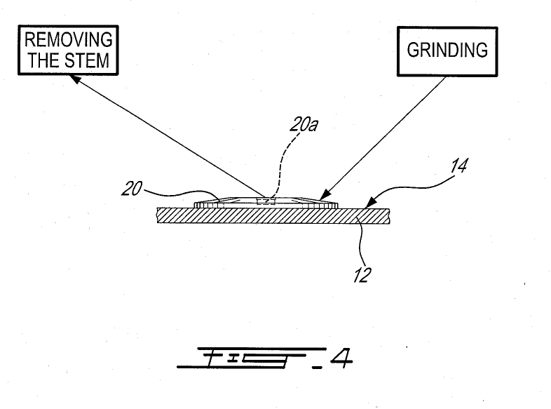

FIG. 3 is a side view showing an example of a damaged stud 16 bonded to a surface made of a composite material in a bypass duct, for instance the outer surface 14 of the wall 12 (FIG. 1). In this example, the stem 18 has damaged threads 26 in the zone identified with reference numeral 28. It should be noted that bonded studs can also have other kinds of damages, including for instance a stem being loose or being broken off from their base plate.

In the case of the damaged bonded stud 16 of FIG. 3, the proposed stud replacement method is initially carried out by removing the stem 18 from the base plate 20. This can be done, for instance, by using a tool such as locking pliers or a similar tool, and by forcing the stem 18 out of the base plate 20. Once this is done, the base plate 20 of the damaged bonded stud 16 will look somewhat similar to what is shown in FIG. 4, the base plate 20 having a hole 20a where the end 18a of the stem 18 was attached.

The proposed replacement method further involves not to remove entirely the base plate 20 of the damaged bonded stud 16. Instead, the base plate 20 is machined or is otherwise worked to reduce its thickness compared to its original value. One possible way to achieve this goal is to grind it using a power tool or a hand-held tool so as to remove material from the upper surface of the base plate 20 and leave only a fraction of its original thickness. The base plate 20 is grinded off to a thickness that is within a predetermined range of values. For instance, the base plate 20 can be ground to leave only about 0.015 to 0.020 inch (0.38 to 0.51 mm) of the original base plate 20. This removes the chamfer of the upper rim 24 of the base plate 20. The base plate 20, however, is not entirely removed to prevent the surface 14 to be damaged by the machining.

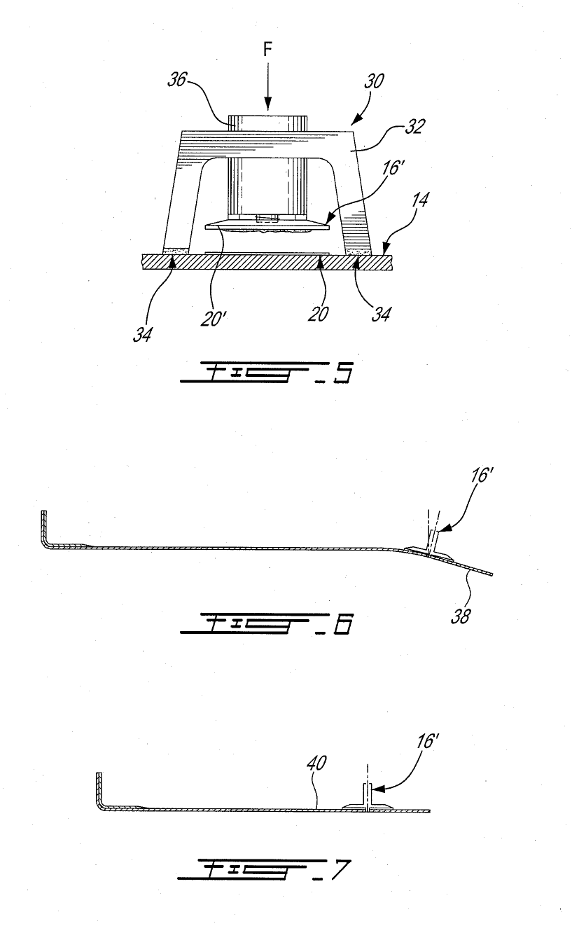

Next, as shown in FIG. 5, a replacement stud 16′ is bonded directly over the remaining portion of the base plate 20 of the damaged bonded stud 16. The replacement stud 16′ can be bonded using an adhesive. The replacement bonded stud 16′ can be positioned prior to its attachment using a positioning jig 30. An example of a positioning jig is shown in FIG. 5. The positioning jig 30 can be used to place the replacement stud 16′ so that its central axis (i.e. the axis at the center of the stem 18) is in registry with the geometric center of the base plate 20 of the damaged bonded stud 16. The positioning jig 30 has a base 32 that is temporarily attached to the composite surface 14, using for instance removable adhesive pads 34, and the replacement stud 16′ is held by a corresponding holder 36 slidingly connected to the base 32. The holder 36 is movable when a positive force F is applied on it. This force will bring the bottom surface of the base plate 20′ of the replacement stud 16′ in contact with the upper surface of the machined base plate 20 of the damaged bonded stud. The force can be maintained for a period of time sufficient for curing the adhesive.

The present method can be used to replace bonded studs in a wide variety of locations on the bypass duct. For instance, a replacement bonded stud 16′ can replace a damaged bonded stud that was connected to a curved surface portion 38, as shown semi-schematically in FIG. 6, or to a flat surface portion 40, as shown semi-schematically in FIG. 7. Wiring or other components can later be reattached to the stems of the replacement bonded studs 16′ once the adhesive is cured.

As can be appreciated, the above-mentioned method mitigate the likelihood of damaging a composite bypass duct upon removing a damaged bonded stud, in particular its base plate, in preparation for the installation of a replacement stud.

Overall, the above description is meant to be exemplary only, and one skilled in the art will recognize that changes may be made to what is described while still remaining within the same concept. For example, studs can have another shape than that shown in the figures. Studs can have a stem whose end is adhesively attached to the base plate instead of being molded therein. The illustrated positioning jig is only one example and other kinds of jigs can be used as well. The replacement studs can be bonded using an adhesive or another kind of connection initially provided on the remaining portion of the base plate of the damaged bonded stud instead of under the base plate of the replacement stud. A replacement stud can be bonded, in some instances, at a location on the remaining portion of the base plate of the previous bonded stud where the central axis of the replacement stud will be slightly offset with reference to the geometric center of the base plate of the previous bonded stud. Still, replacement studs do not necessarily need to be identical in shapes and/or sizes to the previous stud they each replace. Still other modifications will be apparent to those skilled in the art, in light of a review of this disclosure, and such modifications are intended to fall within the scope of the appended claims.

What is claimed is:

1. A method of replacing a stud bonded to a composite bypass duct of a gas turbine engine, the stud comprising a stem attached to a base, the method comprising the steps of:
removing substantially all of the stem of the stud from the base;
reducing the base in thickness to a desired thickness; and then
bonding a replacement stud over a remaining portion of the base.

2. The method as defined in claim 1, wherein the base comprises a non-metal plate bonded to the stud, wherein the stud is metal, and wherein the base plate is bonded to the bypass duct.

3. The method as defined in claim 2, wherein the step of removing includes separating the metal stud from the base plate.

4. The method as defined in claim 1, wherein the base is bonded to an outer portion of the bypass duct, and hence the base has a height projecting above a nominal bypass duct surface.

5. The method as defined in claim 1, wherein the step of reducing the base in thickness includes at least one of machining the base and grinding the base.

6. The method as defined in claim 1, wherein removing substantially all of the stem includes pulling the stem to break it off from the base.

7. The method as defined in claim 1, wherein the step of bonding the replacement stud comprises positioning the replacement stud using a positioning jig temporarily attached to the bypass duct, the jig having a stud-holding portion positioned above the remaining portion of the base.

8. The method as defined in claim 7, wherein the step of bonding the replacement stud includes providing an adhesive between a base of the replacement stud and the remaining portion of the base of the removed stud.

9. The method as defined in claim 1, wherein the replacement stud has a central axis that is coaxial with a geometric center of the base of the removed stud.

10. The method as defined in claim 1, wherein the remaining portion of the base of the stud has about 0.015 to 0.020 inch in thickness above a peripheral outer surface of the bypass duct in the region of the base.

11. A method of replacing a stud bonded to an outer surface of a bypass duct of a turbofan gas turbine engine, the surface being made of a composite material, the stud having a base and had a stem that has been previously removed by separating the stem from the base, the method comprising the steps of:
reducing the base in thickness; and then
bonding a replacement stud over a remaining portion of the base.

12. The method as defined in claim 11, wherein the step of reducing the base in thickness includes machining the base.

13. The method as defined in claim 11, wherein the step of reducing the base in thickness includes grinding an upper surface of the base.

14. The method as defined in claim 11, wherein the step of bonding the replacement stud comprises initially positioning the replacement stud using a positioning jig.

15. The method as defined in claim 14, wherein the step of bonding the replacement stud includes providing an adhesive between a base of the replacement stud and the remaining portion of the base of the replaced stud.

16. The method as defined in claim 11, wherein the replacement stud has a central axis that is coaxial with a geometric center of the base of the replaced stud.

17. The method as defined in claim 11, wherein the remaining portion of the base has about 0.015 to 0.020 inch in thickness.
